(19) United States
(12) Patent Application Publication
(10) Pub. No.: US 2005/0129901 A1
(43) Pub. Date: Jun. 16, 2005

(54) Molded article with adhesion-resistant reinforcing member and method

(75) Inventors: Phillip Swindler, Provo, UT (US); Dennis Danzik, Paradise Valley, AZ (US); David Laws, Provo, UT (US); L.E. Atkins, Orem, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Mity-Lite, Inc.

(21) Appl. No.: 11/003,709

(22) Filed: Dec. 3, 2004

Related U.S. Application Data
(60) Provisional application No. 60/529,007, filed on Dec. 12, 2003.

(51) Int. Cl. B29C 44/12; B29C 41/04; B29C 41/20

(52) U.S. Cl. 428/76; 264/45.7; 264/46.7; 264/279.1; 264/310

(57) ABSTRACT

A molded article includes a rotationally-molded body of polymer material, and a reinforcing member substantially encased within and in direct contact with the polymer material. Both the polymer material and the reinforcing member have their own unique post-molding shrinkage characteristics. The reinforcing member has a surface that substantially eliminates adhesion with the polymer material, so as to enable displacement of the reinforcing member with respect to contacting polymer material, and thereby reduce post-molding deformation of the molded article.

### PRIORITY CLAIM

The present application claims priority from U.S. Provisional Patent Application Ser. No. 60/529,007, filed on Dec. 12, 2003.

### BACKGROUND OF THE INVENTION

1. Field of the Invention

The present invention relates generally to molded polymer articles. More particularly, the present invention relates to a molded polymer article with an expanded foam core and a reinforcing member encased within the foam core, the reinforcing member resisting adhesion with the foam material.

2. Related Art

Polymer materials have come into use for the fabrication of lightweight articles, such as tables, risers, shipping pallets, etc. Some of these types of articles include plastic layers or grid frameworks as reinforcing members, with outer plastic layers in various forms. They may be fabricated by forming a skin, such as by blow molding, rotational molding, injection molding, or vacuum forming to produce a plastic shell, with a frame disposed in the shell or connected to the exterior of the shell to add structural rigidity. In some cases, an expansive foam material, such as polyurethane foam, may be injected into the shell to fill the interior and increase the stiffness of the molded article.

Other methods have been developed for rotational molding of such articles, including methods that produce a rotationally molded polymer article having a polymer shell with a foam core produced in a single step or “one-pass” molding process. Additionally, these methods allow the production of a molded article having an integrated structural frame that is encased by the foam core. Such processes can produce high quality lightweight reinforced plastic articles or structures, and include fewer steps and fewer secondary processes than some prior methods.

Unfortunately, an integrated structural frame presents certain additional challenges with one-pass molded articles. The structural frame generally has different thermal expansion characteristics than the polymer material, both the polymer shell and the foam core. After the molding process is complete, the polymer table will tend to shrink significantly, both because of cooling and because of phase-change densification of the polymer materials. However, an integral frame member, which is frequently of metal, such as steel, will have no phase-change related shrinkage, and will experience significantly less thermal shrinkage because its coefficient of thermal expansion is much smaller than that of the polymer material. If the polymer material bonds or adheres to the frame, the differential shrinkage of these members can produce significant internal stress inside the molded article. The result of these factors is that the molded article is much more likely to experience undesirable post-molding deformation because of the internal stress and differential shrinkage of the components of the article. This deformation can include warping of the article as a whole, localized deformities, local cracking of polymer material, and crushing of the form core material against the ends of the frame members.

### SUMMARY OF THE INVENTION

It has been recognized that it would be advantageous to develop a molded article with a foam core and an encased reinforcing member that resists post-molding shrinkage-related deformation.

It would also be advantageous to develop a molded article wherein there is minimal internal stress created by differential post-molding shrinkage of the foam core and frame.

It would also be desirable to develop a system and method for producing such a molded article.

In accordance with one aspect thereof, the invention provides a molded article, comprising a rotationally-molded body of polymer material, and a reinforcing member substantially encased within and in direct contact with the polymer material. Both the polymer material and the reinforcing member have their own unique post-molding deformation characteristics. The reinforcing member has a surface that substantially eliminates adhesion with the polymer material, so as to enable displacement of the reinforcing member with respect to contacting polymer material, and to reduce post-molding deformation of the molded article.

In accordance with another aspect of the present invention, the invention provides a method for reducing deformation in a molded article. The method includes the steps of placing into a mold a metal reinforcing member having a surface configured to resist adhesion to polymer material, and forming, at an elevated temperature, an article of polymer material within the mold, the polymer material surrounding and contacting the reinforcing member. The reduced adhesion between the polymer material and the reinforcing member advantageously reduces post-molding shrinkage-related deformation of the article.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a pictorial view of a molded tabletop having a foam core with a reinforcing member encased therein, in accordance with the present invention.

FIG. 2 is a cross-sectional view of the molded tabletop of FIG. 1.

FIG. 3 is an elevation view of a rotational molding system configured for forming a molded article in accordance with the present invention.

FIG. 4 is an edge view of a molded article showing possible shrinkage-related deformation of the article.

FIG. 5 is a pictorial view of an open mold configured for receiving reinforcing members for rotational molding of an article.

FIG. 6 is a bottom view of a molded table having encased reinforcing members.

FIG. 7 is a cross-sectional view of a mold configured for making a molded article in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

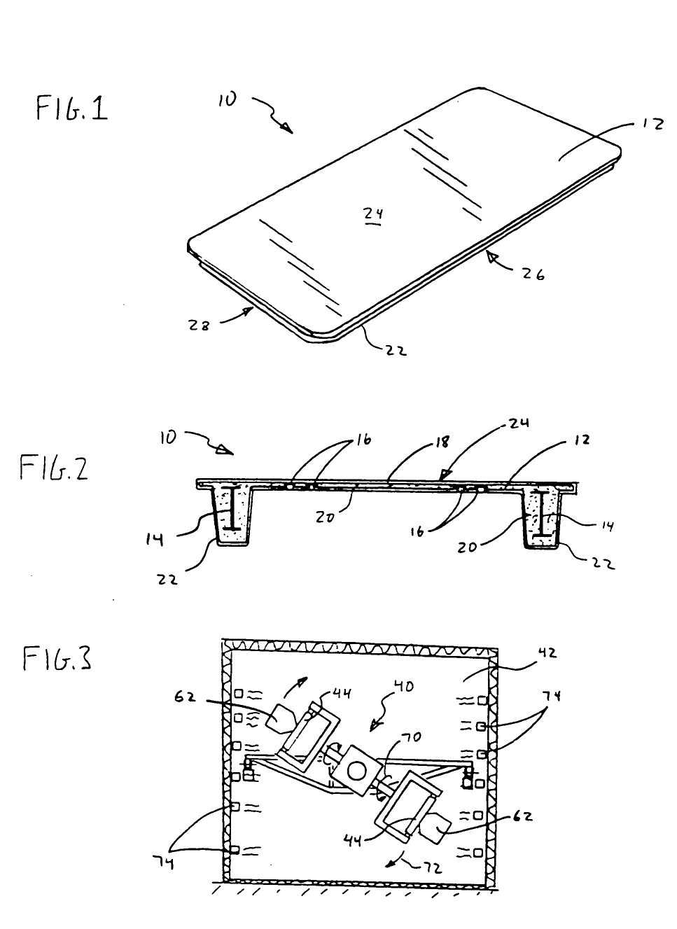

The present invention advantageously provides a molded article or structural member and a system and method for manufacturing the same. The system and method can be used to produce a wide variety of different molded articles in accordance with the invention. One example of such a molded article is a molded table 10 shown in FIGS. 1, 2, and 6. The table shown in these figures comprises a rotationally-molded body 12 of polymer material, with internal reinforcing members 14, such as a table frame, substantially encased within the polymer material. The table may also include attachment points 16 encased within the polymer material. These attachment points can provide points for the attachment of external structure, such as brackets 38 for a folding table leg assembly 39, as shown in FIG. 6. In the embodiment shown, the molded body comprises an outer polymer shell or skin 18, and an expanded polymer foam core 20 disposed within the shell and encasing the reinforcing members. The polymer shell or skin and foam core can be of a variety of thermoset plastic or thermoplastic materials, such as polyethylene, polypropylene, polyvinyl chloride, or composite polyester. Other materials may also be used. The polymer materials may contain additives such as ultraviolet light inhibitors, anti-oxidants, reagents, or color additives, as desired. Additionally, the shell and core may be of similar or dissimilar polymer materials.

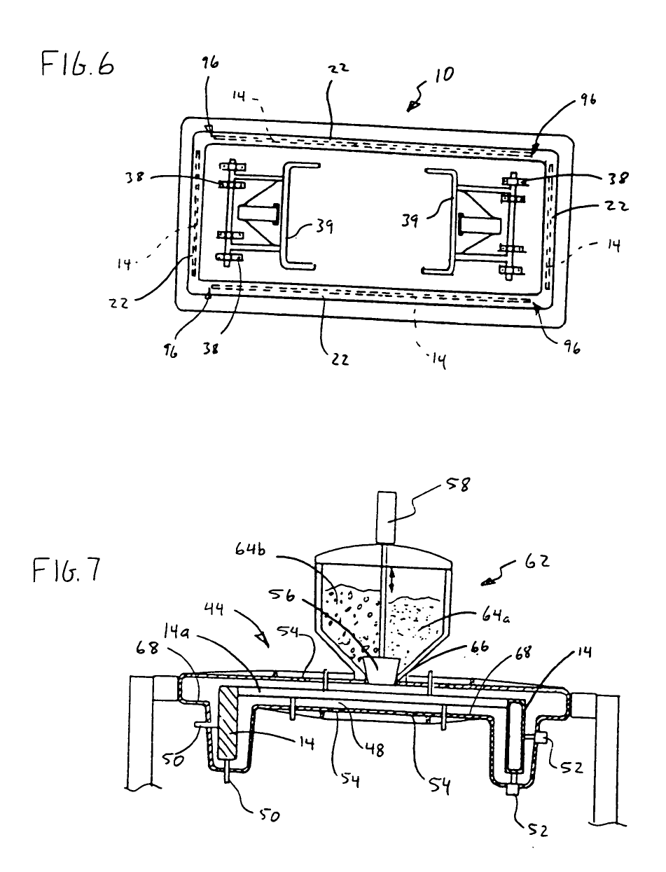

The table frame shown in FIGS. 2 and 5 comprises elongate beams or table runners 14, such as a solid structural “I” beam shape. Other shapes of reinforcing members can be used, such as solid rectangular shapes, shown on the left side of FIG. 7, tubular members, shown on the right side of FIG. 7, channels, etc., and these may be of a variety of materials, such as wood, metals, polymers, composites, etc. Polymers and composites can be used for reinforcing members so long as they are stable at and are not damaged by temperatures that will be reached during the molding process.

The location and configuration of reinforcing members will depend on the shape and intended use of the molded article. For the table shown in FIGS. 1, 2, and 6, the frame comprises table runners 14 incorporated into a skirt 22 which extends downwardly from the tabletop portion 24. It will be apparent that the table frame can be placed in other locations and have a different configuration from that shown. For example, the table frame may include beams or runners along the long sides 26 and also on the short sides 28 of the table. As shown in FIG. 7, the table frame may also include one or more transverse or diagonal frame members 14a extending between the longitudinal beams. It is also conceivable that the table could be configured without an internal frame at all, or with only longitudinal frame members, such as only in the skirt 22 on the long sides 26 of the table. Alternatively, the table may have a frame that extends only around its perimeter, whether in the skirt or table top 24. Many other framed and unframed configurations are also possible.

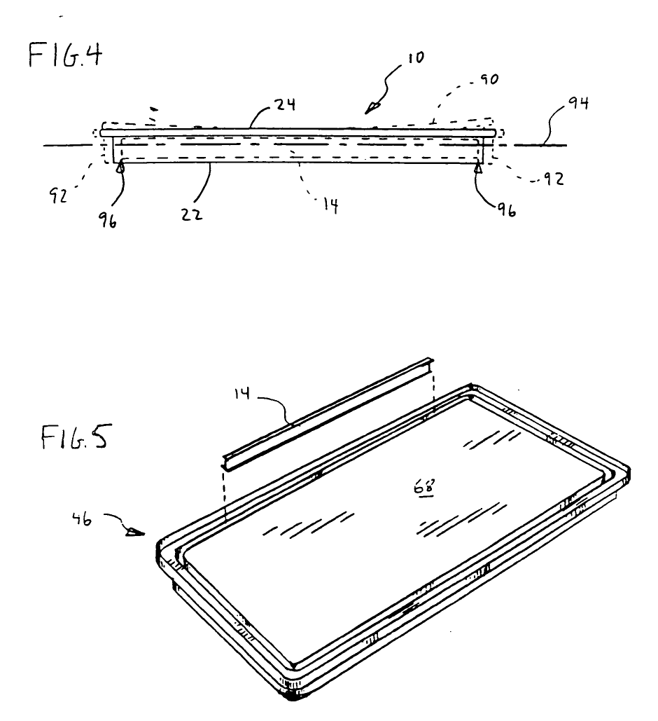

Advantageously, a molded article with all of these elements can be completely formed in a mold in a single step. The method produces a very strong article which is durable, resists delamination of the skin from the foam core, and interacts as a unit with the reinforcing members. An apparatus for making a molded table in accordance with the invention is depicted in FIGS. 3, 5 and 7. FIG. 3 depicts a rotational molding apparatus 40 disposed within a large oven 42 configured for heating the mold while it rotates about multiple axes. FIGS. 5 and 7 provide different views of a mold 44 suitable for producing a table having a cross-section like that of FIG. 2. The lower half 46 of an open mold is shown in FIG. 5, while FIG. 7 provides a cross-sectional view of one embodiment of a closed mold assembly. The mold can be manufactured from metals, such as cast aluminum, fabricated sheet aluminum, or other suitable cast or composite materials, such as steel, iron, etc. Cast aluminum appears to provide a good balance between cost, weight, and heat transfer characteristics.

In order for the reinforcing members 14 to become substantially encased in the polymer material of the molded article, they must be held in a proper position within the interior 48 of the mold. There are several ways that this can be accomplished. In one embodiment, shown on the left side of FIG. 7, the mold 44 includes pins 50 for supporting and holding the frame 14 within the inner cavity of the mold. These pins can be attached to the inside walls of the mold, or extend through holes in the wall of the mold, and operate to support or suspend the structural frame within the inner cavity of the mold prior to and during the molding process as it becomes encapsulated by the skin and expanded foam material. Such pins may be of metal, and may be adjustable or removable from outside the mold. Alternatively, the pins may be of a polymer material which melts and becomes part of the tabletop during the heating and molding process.

Alternative frame supports are shown on the right side of FIG. 7. In this embodiment, the frame supports comprise magnets 52, attached to or through the wall of the mold 44. The magnets can also extend into the mold. So long as the frame members comprise ferromagnetic material, they can be held in place in the mold with suitable magnets. It will be apparent that reinforcing members may also be supported within the mold 44 in other ways. For example, the frame can be supported within the mold cavity by attachment plates, bolt sockets, or other mechanical fastener-related structures (not shown) which extend to or through the mold walls and serve the same function as the pins 50 or magnets 52. Such other methods can allow for insert-molding of fastener systems, whether attached to the internal frame, or encapsulated within the shell 18, or within the integrally molded polymer core 20. The fasteners or other inserts allow for the attachment of leg systems, and other accessories to the plastic table structure. Other mechanical supports to suspend the frame in the mold may also be used. The mold can also include other features that are common for such molds, such as breather tubes 54, which help equalize pressures in the mold and allow gasses to escape.

The process of molding an article in accordance with the invention can proceed in one of several different ways, and the configuration of the mold will depend on the particular method employed. One method involves the use of a drop box or canister 62 disposed on the outer periphery of the mold 44, as shown in FIG. 7. Drop boxes are well known in the art of rotational molding. The drop box is designed to hold materials 64 which are intended to “drop” or flow into the mold at a set time (or temperature) during the rotational molding process. Such materials can include one or more raw polymer materials, and could include a foaming agent mixed therewith. The drop box is mounted on the outer periphery of the exterior mold surface, with an access hole 66 provided from its interior chamber to the inner cavity 48 of the mold. The drop box depicted in FIG. 7 includes a plunger 56, which normally blocks the access hole, but when actuated, draws away from the access hole to allow the polymers stored inside the canister to flow into the inner cavity of the mold. The plunger may be pneumatically, electrically, or hydraulically actuated, such as by an actuator 58. Furthermore, its actuation may be triggered electrically, through either a hard-wired connection, or a wireless radio frequency control system. Opening of the drop box may be controlled electrically, through either a hard-wired connection, or a wireless radio frequency control system, or through other electrical, mechanical, or other processes.

The drop box can have multiple chambers, as shown in FIG. 7, or multiple drop boxes can be attached to a single mold to allow more than one “drop” or discharge of material into the mold during the molding process. For example, the drop box depicted in FIG. 7 contains a first polymer material 64a, which may be, for example, polymer pellets of relatively small size, and a second polymer material 64b, which may be a polymer having larger sized particles. The walls of the drop box are heavily insulated, and the materials surrounding the aperture 66 are selected to prevent adhesion of the contained polymer material thereto. The insulation allows the material contained in the drop box to remain at a lower temperature than the mold itself, for reasons which will become more apparent hereafter.

In the process, the mold 44 is first opened and its interior surface 68 is treated with a release agent, which allows the finished product to be easily removed from the mold. Suitable release agents include silicones, Teflon, etc. These and other suitable release agents are well known in the art, and are readily commercially available. Following treatment of the interior surface of the mold, the desired reinforcing members, such as a structural load-bearing frame 14, attachment points 16, etc. are then inserted into the inner mold cavity 48. This step may also include the installation of pins, mounts, magnets, mechanical fastener-related structures, or other devices described above for holding the reinforcing members in the proper location during molding.

After insertion of the frame and/or other reinforcing members, raw polymer material, usually in the form of powder or pellets, is placed in the mold 44 in accordance with any of several different methods. In one embodiment of the method, the raw polymer material placed into the mold at the outset of the process is only that material needed for forming the thin polymer shell or skin 18 of the table. This polymer material is usually in the form of powder or pellets, though liquids may also be used, and these may be sprayed onto the interior surface 68 of the mold. The polymer material for forming the polymer shell can be configured (such as by including additives) to provide various desired properties, including color, abrasion resistance, opacity, translucence, multiple color surfaces, impact resistance, and structural strength.

At this point, with the frame and the polymer for forming the shell in place, the mold 44 can be closed. One or more drop boxes 62 can be attached to the mold, as described above, and one or more raw polymer materials placed into the drop box(es). These materials are usually also in the form of powder or pellets. The mold is then attached to the rotational molding machine 40 and placed within the oven 42, as shown in FIG. 3. The rotational molding machine is configured to slowly, continuously rotate the mold about two orthogonal axes (as shown by arrows 70, 72) within the oven, so as to allow the polymer material to spread throughout the mold while being simultaneously heated. Suitable rotational speeds vary from about 1 rpm to about 16 rpm. Rotational speeds in the range of about 6 rpm to about 8 rpm are also frequently used.

As the mold rotates, the polymer for forming the skin 18 is caused to spread out within the mold. Simultaneously, the oven 42, having heating elements 74, heats the mold, which causes the polymer particles to begin to melt and adhere to the inner surface 68 of the mold. It will be apparent that a variety of heating systems can be used for heating the oven, such as gas-fired convection systems, etc. The result of the heating and rotating is to form an exterior shell of the melted first polymer around the entire inner surface of the mold. At a preset time or temperature, the drop box 62 opens, allowing some or all of its contents 64 to flow into the mold. The material from the drop box can be a second polymer material containing reagents that will cause the second polymer material to “blow” or foam in a controlled manner at a predetermined temperature to form the foam core. This temperature may be approximately the same as the temperature at which the skin forms, or may be a different temperature. However, because the drop box is thermally insulated, the second polymer will not have reached the same temperature as the mold by the time the first or shell polymer does. Consequently, the same material, e.g. polyethylene, may be used for both the shell and the foam core, the only difference being that the polymer of the core includes the blowing agent so as to expand into a foam, while the shell polymer does not. Because of the timing of their exposure to the reaction temperature, the desired reactions will occur at different times.

Many “drops” of polymer materials, colors, or reagents may be made into the mold cavity as desired, whether from a single drop box having more than one chamber, or from multiple drop boxes (not shown). For example, after the first polymer material is allowed to form the shell 18, a second shell polymer material (without a foaming agent) may be dropped into the mold, to form a second shell layer inside the first. Thus one or more additional layers of polymer may be deposited inside the outer shell layer. The second and subsequent layers of polymers preferably have characteristics (such as different melting temperatures) such that each layer will mold, in sequential order, after the preceding outer shell has been formed.

Alternatively, the polymer pellets may be of various sizes, each size melting and reacting at different times during the heating cycle. In general, the smaller the pellet, the faster the melt—similar to a time-release system. The heating cycle heats the mold and its contents from room temperature up to a certain maximum temperature, depending on the specific properties of the polymer materials that are being used. In one embodiment of the invention, using polyethelyne for the shell material, the temperature at which the shell begins to form is about 270° F., and the temperature at which the foam core forms is about 310° F. However, with other materials, the temperatures will differ. The melt temperature of nylon, for example, whether for the shell or the foam core, is between about 347° F. and 509° F.

A variety of different materials can be placed into the mold 44 at the beginning of the process (without using a drop box) and still produce the different layers. Where these materials have different properties, they can form successive layers of the table, including both the shell 18 and foam core 20, even while intermixed. For example, each shell layer material may have a slightly different melt temperature, such that it will melt and adhere to the inside 68 of the mold (or the preceding shell material) at different times during the molding process. Additionally, polymer material and a foaming agent with a melt and foaming temperature that is higher than the melt temperature of the shell material can be placed in the mold at the outset, and thus form the foam core in natural sequence.

Many different kinds of foams may be used for the foam core in connection with any of the above-described methods. For example, two kinds of olefinic foams have been used by the inventors. Azodicarbonamide foams produce nitrogen gas (N₂) and carbon dioxide (CO₂), as the blowing agents, but also produce ammonia (NH₄) and carbon monoxide (CO) as byproducts. Obviously, carbon monoxide is poisonous, and ammonia has an objectionable smell, and is also toxic in large quantities. Alternatively, sodium bicarbonate-based foams have also been used, these producing carbon dioxide (CO₂) as the blowing agent, with no objectionable byproducts. This latter method is preferred. Through this process, two similar (or perhaps even dissimilar) materials, the skin polymer and the foam polymer, form a laminate which becomes integrally connected into a strong mass. When viewed in cross-section and on a magnified scale, the unexpanded material of the shell 18 gradually transitions into the expanded foam material of the core 20, such that there is no distinguishable interface between the two materials. To the naked eye, the transition from the non-expanded shell to the expanded foam core material may not appear gradual. However, because the core material and shell material are placed and cured together and may be the very same type of material, the transition from one to the other primarily represents a change in density, rather than an interface between two materials. Consequently, there is no weakened interface between the shell and the core, thus greatly reducing the problem of delamination of the skin from the foam core, even when subjected to heat and other stress.

One advantage of this method is that olefinic foams are substantially less expensive than injected foams, such as polyurethane foam. Thus, the method of this invention allows less expensive foam materials to be used for lightweight table cores which could not be used before. Olefinic foams also produce far less fluid pressure (˜5 psi) than injected foams (which produce ˜40-50 psi), thus allowing their use in relatively lightweight and less expensive rotational molds. The “blowing” or foaming reaction of sodium bicarbonate-based foams is an endothermic reaction. However, exothermic foaming agents can also be used in accordance with the method of this invention.

The maximum temperature may be maintained for some period of time to allow the desired reactions to go to completion, or upon reaching the desired temperature, the heating cycle may be immediately discontinued. In one embodiment of the invention, the heating cycle lasts approximately 25 minutes. When the heating cycle is completed, the mold assembly is removed from the oven, and placed in a cooling area (not shown) for a given time period. In one embodiment of the invention, the cooling cycle lasts for about 35 minutes. While the mold is cooling, additional material drops may also be made in the inner cavity of the mold. After cooling, the mold may be opened and the molded part removed, after which the process can be repeated.

The method as described produces a unique plastic table structure. The plastic table structure utilizes a combination of a foam core, encapsulated within a polymer shell having one or more layers, to produce a plastic table that is very strong and has high impact resistance. Advantageously, the foam core and polymer skin may be of the same species of material, simply in different forms or densities (i.e. foam vs. higher density skin), thus providing an integral transition from the core to the skin, and thereby drastically reducing the possibility of delamination. The unique concurrently molded polymer core system produces a solid platform that resists crushing and also inhibits ultraviolet degradation.

The table structure can also be modified with a variety of cosmetic and functional features. For example, inserts of various kinds (not shown) can be placed in the mold before molding, so as to be incorporated into the finished table. These may include laminate inserts for the tabletop, protective edge bands, facia pieces, and the like. For example, a layer of ultra-thin Corian® or other durable laminate material could be placed into the mold to provide a tabletop that has superior surface qualities in an inexpensive polymer shell. This process could be used to produce things such as laboratory benches, and highly impermeable surfaces for use where granite and other such materials are currently used. It will be apparent that laminates and other such additions could also be applied to the finished tabletop after the molding process is complete.

One challenge presented by rotationally-molded articles is shrinkage and deformation after molding. As a rotationally-molded article cools down after formation, its material shrinks, due to both thermal cooling and phase-change densification, as explained above. Naturally, this shrinkage induces internal stress in the article, and, depending upon the geometry of the article, this stress can cause significant deformation. Referring to FIG. 4, there is shown an edge view of a table 10 according to the present invention, showing possible shrinkage-related deformation of the table. The table is geometrically irregular, having a large, planar tabletop 24, and a skirt 22 that is perpendicular to the tabletop and extends around the table perimeter on the bottom side. Because of this geometry, as the table cools and shrinks, the shrinkage stress in the tabletop tends to cause it to warp and cup, as shown by the dashed line 90 in FIG. 4. Additionally, as the table cools, its length will shrink, as indicated by the dashed lines 92.

When an internal frame 14 is incorporated into a rotationally-molded article, this tends to further complicate shrinkage-induced deformation. The frame is likely to have temperature-related shrinkage properties that are substantially different than those of the polymer material of the molded article. For example, an internal frame of steel has a significantly different coefficient of thermal expansion than polyethylene, which will change the nature and magnitude of shrinkage-induced mechanical stress inside the structure. Whether the frame bonds to the internal foam core material will also affect the nature and degree of internal stress. These problems can cause additional warping, or make the warping more severe or difficult to predict.

The elongate reinforcing member 14 in the completed table 10 is in direct contact with the foam material of the core 20. The polymer material of the table body, both the foam core and the shell or skin 18, has post-molding deformation characteristics, including post-molding shrinkage, and thermal expansion. During the molding process, quantities of foaming gasses (e.g. ammonia or carbon dioxide) are produced by the foaming agent used to create the foam core. After molding, as the foam material hardens, there is some continued escape of these gasses and phase-change shrinkage of the polymer, which causes the foam material to shrink. Additionally, as with all materials, the polymer materials (both the skin and the core) have a coefficient of thermal expansion. As these materials cool, they shrink. The reinforcing member also has post-molding deformation characteristics—principally a coefficient of thermal expansion. However, the reinforcing member has different thermal expansion characteristics than the polymer material. The reinforcing member, which is frequently of metal, such as tubular steel, experiences no phase-change related shrinkage during the molding process, and will experience significantly less shrinkage related to cooling because its coefficient of thermal expansion is much smaller than that of the polymer material.

One method for dealing with warping or other undesirable deformation of rotationally molded articles is to modify the shape of the mold to anticipate potential warping. For example, to eliminate undesirable warping of a rotationally-molded tabletop, the top surface of the mold can be slightly curved in a direction opposite the anticipated direction of warping, so that as the item cools, the natural shrinkage-induced warping will bring the tabletop to the desired flat shape. As shown in FIG. 4, the tabletop 10 shrinks relative to a shrink-neutral axis 94. This axis represents a plane within which shrinkage does not produce a change in relative shape. Above and below the shrink-neutral axis, the relative shape of the table changes due to shrinkage. The location of the shrink-neutral axis depends upon the geometry of the article. Because certain portions of the structure have greater stiffness in the direction of shrinkage, warping will vary accordingly. Another method for dealing with warping is to prestress or preload the frame member, so that, after molding, when the prestress is released, the frame will compensate for anticipated warping of the polymer body.

The inventors have found that warping can be reduced through proper attention to the placement of an internal frame member with respect to the shrink-neutral axis 94. For example, reinforcing members, such as the elongate frame members 14, can be placed with their neutral axis coincident with the shrink-neutral axis of the tabletop. This configuration helps prevent differences in thermal expansion between the frame and tabletop from causing additional warping. The bending stiffness of the frame member also helps reduce the normal warping that would occur if no frame member were present.

Additionally, the inventors have found it desirable to use a frame member that does not bond to the material of the foam core. If the beam 14 does not bond to the expanded foam material of the core 20, the foam material can “slide” along the sides of the beam as it shrinks, and only a small, localized shrinkage region 96 adjacent to an end of a beam may crush due to shrinkage, without causing significant warping or deformation of the article. Accordingly, the inventors have found that applying a non-stick coating to the frame members prevents bonding of the foam core to the frame member. For example, with a rolled steel elongate frame member, the inventors have applied Loctite® Frekote® 4368 to the metal to prevent adhesion of the polymer material. This type of coating adheres strongly to the metal frame member, is not affected by the high temperatures of the rotational molding process, is inexpensive, easy to apply, and is readily commercially available.

Other non-stick coatings or treatments can also be used, such as Teflon® film, graphite, wax, and zinc or magnesium stearate. It will be apparent that an appropriate non-stick agent will depend on the material of the frame and the particular polymers used in the molded article. For example, the inventors have also used a wood frame member wrapped with Teflon® film (e.g. about 3 mils thick) in accordance with the method of this invention. While the reinforcing member does not adhere to the foam core material, it is nevertheless fully encased within it and fully supported along its length, so that full structural interaction is maintained between the frame and the molded article.

The invention thus provides a molded article having a polymer shell and an expanded polymer foam core, with an integral frame encased within the foam core. Advantageously, the article can be produced in a one-pass rotational molding process, either with or without a drop box attached to the mold. The process is quick and efficient, and because of the mount system for reinforcing members, turn-around time for individual molds is reduced. Additionally, the provision of a non-stick coating on the reinforcing members helps reduce deformation around these members, while still providing strong anchorage of the members and structural cooperation between the reinforcing members and the polymer material of the body.

By way of example, and without limitation, the invention can be described as providing a structural device, comprising a molded unit of polymer material, having deformation characteristics, and a reinforcing member, encased within the polymer material of the unit and in direct contact therewith. The reinforcing member has substantially different deformation characteristics than the polymer material, and has an interface with the foam material allowing substantially free sliding therebetween.

As another example, the invention can be described as providing a molded article, comprising a rotationally-molded body of polymer material, having post-molding deformation characteristics, and a reinforcing member, substantially encased within the polymer material and in direct contact therewith. The reinforcing member has a surface interface with the polymer material such that adhesion between the polymer material and the reinforcing member is substantially eliminated, so as to enable displacement of the reinforcing member with respect to contacting polymer material, and to thereby reduce post-molding deformation of the molded article.

As another example, the invention can be described as a structural device, comprising a molded unit of polymer material, having an aspect of spatial assymetry, the polymer material having post-molding deformation characteristics that tend to deform the unit. A reinforcing member is encased within the polymer material during molding thereof, producing a reinforcing member-polymer interface, the reinforcing member having post-molding deformation characteristics that are substantially different from those of the polymer material. The reinforcing member-polymer interface allows substantially free sliding between the reinforcing member and the polymer so as to reduce post molding deformation of the molded unit.

As yet another example, the invention can be described as a structural member, comprising a molded polymer shell, an expanded polymer foam within the shell, and a metal reinforcing member encased within the expanded polymer foam. An interface between the expanded foam material and the metal reinforcing member is configured to allow substantially free sliding therebetween.

As yet another example, the invention can be described as a structural member, comprising a molded polymer shell, an expanded polymer foam material within the shell, having a thermal shrinkage factor, and a metal reinforcing member encased within the expanded polymer foam material, having a thermal shrinkage factor substantially different from that of the expanded foam material. An interface between the expanded foam material and the metal reinforcing member is provided such that thermal shrinkage of the polymer foam material adjacent to the reinforcing member is substantially unresisted by friction along the interface.

As yet another example, the invention can be described as a structural member, comprising a molded polymer shell, an expanded polymer foam within the shell, and a metal reinforcing member encased within the expanded polymer foam and in contact therewith. The reinforcing member has a non-stick surface, so as to allow substantially free sliding of the expanded polymer material against the surface of the reinforcing member.

As yet another example, the invention can be described as a table top, comprising a molded polymer shell defining a table top, a core of expanded polymer foam material, disposed within the polymer shell, a metal reinforcing member, encased within the foam core material and in contact therewith. The reinforcing member has a non-stick surface, such that adhesion between the foam material and the metal reinforcing member is substantially reduced.

As yet another example, the invention can be described as a method for reducing deformation in a molded article. The method includes the steps of placing into a mold a metal reinforcing member having a surface configured to resist adhesion to polymer material, and forming, at an elevated temperature, an article of polymer material within the mold, the polymer material surrounding and contacting the reinforcing member. The reduced adhesion between the polymer material and the reinforcing member reduces post-molding shrinkage-related deformation of the article.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

1. A molded article, comprising:
a rotationally-molded body of polymer material, having post-molding deformation characteristics;
a reinforcing member, substantially encased within the polymer material and in direct contact therewith, the reinforcing member having a surface interface with the polymer material such that adhesion between the polymer material and the metal stiffener is substantially eliminated, so as to enable displacement of the reinforcing member with respect to contacting polymer material, and to reduce post-molding deformation of the molded article.

2. A molded article in accordance with claim 1, wherein the rotationally-molded body is a table top.

3. A molded article in accordance with claim 2, wherein the reinforcing member is an elongate table runner.

4. A molded article in accordance with claim 3, wherein the table runner is disposed within a skirt of the table top.

5. A molded article in accordance with claim 1, wherein the reinforcing member is a blind fastener configured for attachment of external structure to the table top.

6. A molded article in accordance with claim 5, wherein the blind fastener comprises a nut attached to a backing plate, the nut having a threaded opening, the blind fastener being disposed in the mold such that the threaded opening of the nut is exposed and substantially flush with an exterior surface of the molded article, and the backing plate is substantially completely encased within the polymer material.

7. A molded article in accordance with claim 6, wherein the threaded opening of the nut is shielded from entry of polymer material by the backing plate.

8. A molded article in accordance with claim 5, wherein the blind fastener is configured for attachment of table leg structure.

9. A molded article in accordance with claim 8, wherein the table leg structure comprises a folding leg mechanism.

10. A molded article in accordance with claim 1, wherein the rotationally-molded body of polymer material comprises comprises a polymer shell and a core of expanded foam polymer material encased within the shell, the reinforcing member being substantially encased within the expanded foam core.

11. A molded article in accordance with claim 1, wherein the post-molding deformation characteristics of the polymer material are related to thermal shrinkage and phase-change densification of the polymer material.

12. A molded article in accordance with claim 1, wherein the reinforcing member is of metal, and further comprising a non-stick coating disposed on an external surface of the reinforcing member.

13. A molded article in accordance with claim 12, wherein the non-stick coating is selected from the group consisting of graphite, wax, zinc, magnesium stearate, and Teflon® film.

14. A structural device, comprising:
a molded unit of polymer material, having an aspect of spatial assymetry, the polymer material having post-molding deformation characteristics that tend to deform the unit;
a stiffener, encased within the polymer material during molding thereof producing a stiffener-polymer interface, the stiffener having post-molding deformation characteristics that are substantially different from the post-molding deformation characteristics of the polymer material, the stiffener-polymer interface allowing substantially free sliding between the stiffener and the polymer so as to reduce post molding deformation of the molded unit.

15. A structural device in accordance with claim 14, wherein the molded unit of polymer material comprises a molded polymer shell, and an expanded polymer foam within the shell, the stiffener being encased within the expanded polymer foam.

16. A structural device in accordance with claim 14, wherein the molded unit of polymer material comprises a table top, and the stiffener is selected from the group consisting of a metal table runner, encased within a skirt depending from the table top, and a blind fastener, disposed so as to be flush with an external surface of the table top.

17. A structural device in accordance with claim 14, further comprising a non-stick coating, disposed on an external surface of the stiffener.

18. A method for reducing deformation in a rotationally-molded article, comprising the steps of:
placing into a mold of a rotational molding system a metal reinforcing member having a surface configured to resist adhesion to polymer material;
rotating and heating the mold, so as to form an article of polymer material within the mold, the polymer material surrounding and contacting the reinforcing member, the reduced adhesion between the polymer material and the reinforcing member reducing post-molding shrinkage-related deformation of the article.

19. A method in accordance with claim 18, further comprising the step of applying a non-stick coating upon an external surface of the reinforcing member so as to substantially reduce adhesion of the polymer material to the reinforcing member.

20. A method in accordance with claim 18, wherein the step of rotating and heating the mold comprises the steps of:
causing a shell of molten polymer material to form on an inside of the mold while rotating and heating the mold; and
causing polymer material to foam and expand within the shell of molten polymer material while rotating and heating the mold, so as to create an expanded foam core within the shell of polymer material, the reinforcing member being substantially encased within the expanded foam core.

21. A method in accordance with claim 18, wherein the metal reinforcing member is selected from the group consisting of a table runner and a blind fastener.
